(19) United States
(12) Patent Application Publication
(10) Pub. No.: US 2019/0180216 A1
(43) Pub. Date: Jun. 13, 2019

(54) COGNITIVE TASK ASSIGNMENT FOR COMPUTER SECURITY OPERATIONS

(71) Applicant: International Business Machines Corporation, Armonk, NY (US)

(72) Inventors: Penvisa Buraparate, AUSTIN, TX (US); Colin Reilly, Austin, TX (US); Jennifer Pearl Cheuk, Jamaica Plain, MA (US); Shaun Thomas Lynch, Devon (GB); Matthew Dennis Gallo, Travis, TX (US)

(21) Appl. No.: 15/834,453

(22) Filed: Dec. 7, 2017

(51) Int. Cl. G06Q 10/06; G06F 17/30

(52) U.S. Cl. CPC G06Q 10/063112; G06F 17/3053

(57) ABSTRACT

A task assignment system and method may include receiving a computer security offense, analyzing the computer security offense to determine a plurality of computer security offense characteristics, calculating a match score for a plurality of analyst profiles of an analyst profile system, the match score indicating a strength of correlation between an analyst profile and the plurality of computer security offense characteristics, selecting an analyst profile with a highest match score of the plurality of analyst profiles, verifying that the highest match score exceeds a match score threshold, and assigning the task associated with the computer security offense to an analyst associated with the selected analyst profile.

### TECHNICAL FIELD

The present invention relates to systems and methods for computer security offense task assignment, and more specifically the embodiments of a task assignment system for automatically assigning a task to an analyst of a computer security operation center.

### BACKGROUND

Security Operation Centers (SOCs) and other cyber security teams have task systems in place to manage a large amount of tickets received on a daily basis.

### SUMMARY

An embodiment of the present invention relates to a method, and associated computer system and computer program product, for automatically assigning a task to an analyst of a computer security operation center. A processor of a computing system receives a computer security offense. The computer security offense is analyzed to determine a plurality of computer security offense characteristics. A match score is calculated for a plurality of analyst profiles of an analyst profile system, the match score indicating a strength of correlation between an analyst profile and the plurality of computer security offense characteristics. An analyst profile is selected with a highest match score of the plurality of analyst profiles. The highest match score is verified to exceed a match score threshold. The task associated with the computer security offense is assigned to an analyst associated with the selected analyst profile.

### BRIEF DESCRIPTION OF THE DRAWINGS

FIG. 1 depicts a block diagram of a task assignment system, in accordance with embodiments of the present invention.

FIG. 2 depicts an analyst profile of the analyst profile system, in accordance with embodiments of the present invention.

FIG. 3 depicts a flow chart of a method for automatically assigning a task to an analyst of a computer security operation center, in accordance with embodiments of the present invention.

FIG. 4 depicts a detailed flow chart of a method for automatically assigning a task to an analyst of a computer security operation center, in accordance with embodiments of the present invention.

FIG. 5 depicts a block diagram of a computer system for the task assignment system of FIGS. 1-2, capable of implementing for automatically assigning a task to an analyst of a computer security operation center of FIG. 34, in accordance with embodiments of the present invention.

FIG. 6 depicts a cloud computing environment, in accordance with embodiments of the present invention.

FIG. 7 depicts abstraction model layers, in accordance with embodiments of the present invention.

### DETAILED DESCRIPTION

Security Operation Centers (SOCs) and security teams in general typically have task systems in place to manage tickets; however, it is often a very manual process when sorting through a list of offenses and assigning a task to be handled by an analyst of a computer security operation center. The workflow comes in the form of a long list and requires a user to manually sort through the list of tasks associated with a computer security offense to determine which task needs to be dealt with and determine which category that task falls under. Embodiments of the present invention addresses this problem by automatically assigning tasks to a specific analyst based on a cognitive approach, given a characteristic of the offense or task, and analyst specific data. A security to-do board may be created specifically for security teams that not only manage tasks/tickets from issue to close but also pull in offenses from the offense list provided by a Security Information and Event Management system (SIEM) or other security product to a universal board for a security team to refer to and which assigns the tasks to a particular analyst that is optimally suited for dealing with that specific offense type.

Thus, there is a need for a task assignment system for automatically assigning a task to an analysis based on a cognitive approach to the particular offense and analyst-specific data. Embodiments of the present invention may perform/use sentimental analysis and personality insights of an analyst, in addition to parsing computer security offense data, to automatically assign a task associated with the computer security offense to an optimum or ideal analyst that is available.

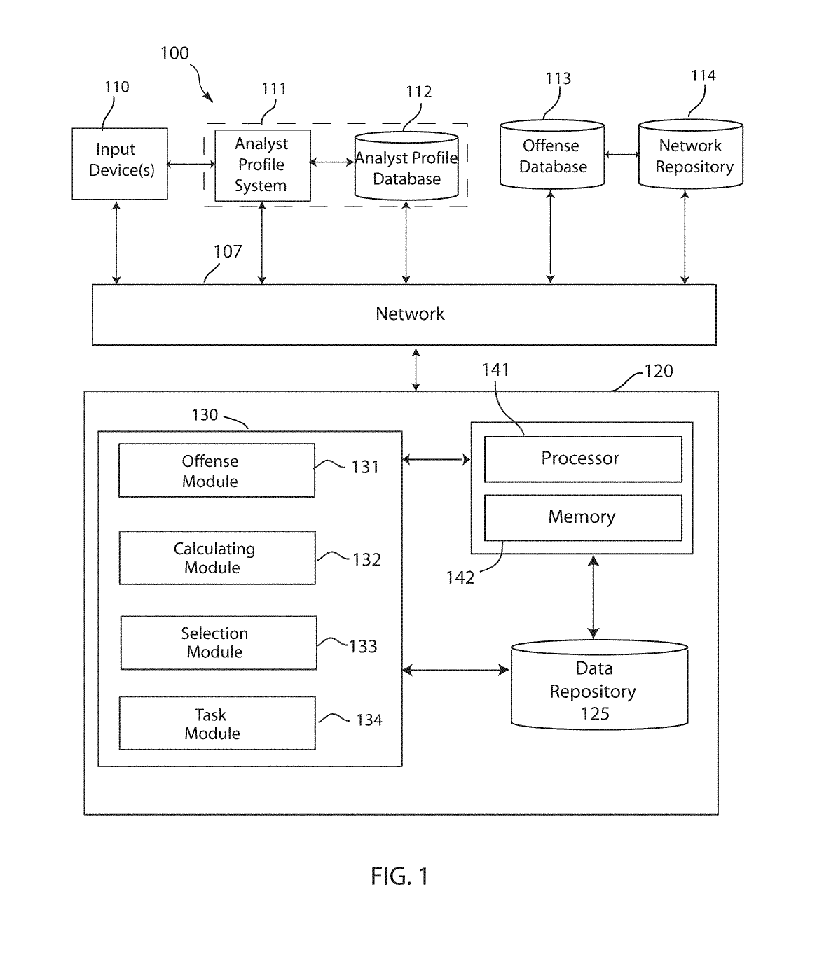

Referring to the drawings, FIG. 1 depicts a block diagram of task assignment system 100, in accordance with embodiments of the present invention. Embodiments of the task assignment system 100 may be for automatically assigning a task to an analyst of a computer security operation center. Embodiments of the task assignment system 100 may be useful for SOCs and similar departments to determine which tasks associated with a computer security offense should be handled by a particular analyst or group of analysts based on a detailed cognitive understanding of each individual computer security offense and analyst-specific data. For example, tasks associated with a particular computer technology field may be assigned to any analyst, regardless of whether one analyst is skilled in the area or prefers the computer technology filed over another analyst. Embodiments of a computer security offense may be an alert, an attack, a cyber security attack, a hardware failure, a website service being don, a distributed denial of service (DDoS) attack, a network interruption, a network resource issue, a repair call, a service request, a request for technical support, a software issue, an enterprise server issue, a computer issue, a network issue, data breach, an IT issue, and the like, which may require the attention of a user, such as computer security analyst of a SOC. In an exemplary embodiment, tasks that are associated with the computer security offense may be assigned to analysts, which may be a particular action to take, problem to solve, protocol to follow, repair to be made, and the like, which can lead to a remediation of the computer security offense.

Embodiments of the task assignment system 100 may be an analyst determination system, a task management system, an analyst determination system, a cognitive task assignment system, a computer security operations task assignment system for analytically and cognitively selecting an ideal and available analyst, and the like. Embodiments of the task assignment system 100 may include a computing system 120. Embodiments of the computing system 120 may be a computer system, a computer, a cellular phone, a mobile device, a desktop computer, a server, one or more servers, a back end server(s), a computing device, a tablet computer, a dedicated mobile device, a laptop computer, other internet accessible/connectable device or hardware, and the like.

Furthermore, embodiments of task assignment system 100 may include one or more input devices 110, an analyst profile system 111, an analyst profile database 112, and an offense database 113, that are communicatively coupled to a computing system 120 of the task assignment system 100 over a computer network 107. For instance, information/data may be transmitted to and/or received from one or more input devices 110, the analyst profile system 111, the analyst profile database 112, and the offense database 113 over a network 107. A network 107 may be the cloud. Further embodiments of network 107 may refer to a group of two or more computer systems linked together. Network 107 may be any type of computer network known by individuals skilled in the art. Examples of network 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network 107 may be a peer-to-peer network in some embodiments, wherein in other embodiments, the network 107 may be organized as a client/server architecture.

In some embodiments, the network 107 may further comprise, in addition to the computing system 120, a connection to one or more network-accessible knowledge bases 114, which are network repositories containing information of the analyst, computer security offense history, analyst performance, etc., network repositories or other systems connected to the network 107 that may be considered nodes of the network 107. In some embodiments, where the computing system 120 or network repositories allocate resources to be used by the other nodes of the computer network 107, the computing system 120 and network-accessible knowledge bases 114 may be referred to as servers.

The network-accessible knowledge bases 114 may be a data collection area on the computer network 107 which may back up and save all the data transmitted back and forth between the nodes of the computer network 107. For example, the network repository may be a data center saving and cataloging user activity data, ticket data, user data, support team data, user preference data, administrator data, and the like, to generate both historical and predictive reports regarding a particular analyst or computer security offense pattern, and the like. In some embodiments, a data collection center housing the network-accessible knowledge bases 114 may include an analytic module capable of analyzing each piece of data being stored by the network-accessible knowledge bases 114. Further, the computing system 120 may be integrated with or as a part of the data collection center housing the network-accessible knowledge bases 114. In some alternative embodiments, the network-accessible knowledge bases 114 may be a local repository that is connected to the computing system 120.

Embodiments of the one or more input devices 110 may be a user/analyst device, such as a cell phone, a smartphone, a mobile device, a mobile computer, a tablet computer, a PDA, a smartwatch, a dedicated mobile device, a desktop computer, a laptop computer, or other internet accessible device, machine, or hardware. Embodiments of the analyst device may be running one or more software applications, such as a calendaring application, fitness application, camera application, and the like. Moreover, embodiments of the one or more input devices 110 may be an input mechanism, such as a sensor, for gathering analyst-specific data. Data gathered from the one or more input devices 110 may be used to provide real-time analyst data for selection of analysts described in greater detail infra.

Referring still to FIG. 1, embodiments of the task assignment system 100 may include an analyst profile system 111. Embodiments of the analyst profile system 111 may be communicatively coupled to the computing system 120 over computer network 107. Embodiments of the analyst profile system of the task assignment system 100 depicted in FIG. 1 may system include a plurality of analyst profiles of analysts of the computer security operation center. For instance, each analyst of the computer security operation center may be profiled, wherein the analyst profile data may be stored or otherwise contained in an analyst profile database 112 coupled to the analyst profile system 111. Embodiments of the analyst profile system 111 may be one or more websites, applications, databases, storage devices, repositories, servers, computers, engines, and the like, that may service, run, store or otherwise contain information and/or data regarding analysts. The analyst profile system 111 may be accessed or may share a communication link over network 107. In an exemplary embodiment, an analyst profile of the analyst profile system 111 may include data regarding an expertise of the analyst, a title of the analyst, an experience level of the analyst, an interest of the analyst, a skill level of the analyst, a success history of the analyst, and the like. The analyst-specific data may be collected by or provided to the analyst profile system 111 based on a plurality sources. A first source may be a training data or evaluation data from a manger about the experience, experience, title, interests, preferences, skills, and the like. These criteria may be entered into the analyst profile database 112 using the analyst profile system 111 by the manager. A second source may be the analyst entering data using a software application on the analyst computing device interfacing with the analyst profile system 111. A third source may be results of sentiment, intent, and/or personality analysis of analyst shared content across various platforms, such as a social media, social network platforms, work collaboration platforms, computer security software applications, etc. A fourth source may be data received from one or more input devices 110 associated with the analyst. The analyst-specific data may be continuously collected and updated in the analyst profile system 111, with data from the plurality of sources.

Furthermore, embodiments of the computing system 120 may be equipped with a memory device 142 which may store various data/information/code, and a processor 141 for implementing the tasks associated with the task assignment system 100. In some embodiments, a task assignment application 130 may be loaded in the memory device 142 of the computing system 120. The computing system 120 may further include an operating system, which can be a computer program for controlling an operation of the computing system 120, wherein applications loaded onto the computing system 120 may run on top of the operating system to provide various functions. Furthermore, embodiments of computing system 120 may include the task assignment application 130. Embodiments of the task assignment application 130 may be an interface, an application, a program, an engine, a module, or a combination of modules. In an exemplary embodiment, the task assignment application 130 may be a software application running on one or more back end servers, servicing a SOC system.

The task assignment application 130 of the computing system 120 may include an offense module 131, a selection module 132, a confidence module 133, and a task module 134. A “module” may refer to a hardware-based module, software-based module or a module may be a combination of hardware and software. Embodiments of hardware-based modules may include self-contained components such as chipsets, specialized circuitry and one or more memory devices, while a software-based module may be part of a program code or linked to the program code containing specific programmed instructions, which may be loaded in the memory device of the computing system 120. A module (whether hardware, software, or a combination thereof) may be designed to implement or execute one or more particular functions or routines.

Embodiments of the offense module 131 may include one or more components of hardware and/or software program code for receiving, detecting, acquiring, creating, and/or establishing a computer security offence. The computer security offense may be received from an offense list provided by a SIEM or other security product or software. For instance, embodiments of the offense module 131 may receive an alert or notification of a computer security offense that may attention from the SOC. In an exemplary embodiment, the offense module 131 may receive and/or process the computer security offense to create/generate a ticket or task, for analysis by the task assignment application 130. Furthermore, embodiments of the offense module 131 may include one or more components of hardware and/or software program code for analyzing the computer security offense to determine a plurality of computer security offense characteristics. Embodiments of the computer security offense characteristics may include an offense type, a complexity of the computer security offense, an estimated time to closing the computer security offense, a technical field of the computer security offense, an urgency of the computer security offense, a severity level of the computer security offense, and the like. For instance embodiments of the offense module 132 may, in response to receiving the computer security offense, analyze the computer security offense to determine the characteristics and other data points from the content of the computer security offense and ticket associated therewith. The content of the computer security offense and/or ticket may be analyzed by a text analysis system that may parse, identify, scan, detect, analyze etc. words using, for example, a natural language processing technique, natural language classification, pre-trained language model, etc. to analyze the content of the computer security offense. The content of the computer security offense may include a source of the offense, a cause of the offense, a nature of the offense, a type of offense, list of components involved, a recency of the issue, a frequency of reported problems, a type of account, a number of times the offense has occurred in the past, a time of day, a day of a week, an amount of downtime, and account specific information, and the like.

Embodiments of the offense module 131 may parse the content to determine keywords that may be helpful in identifying and understanding the plurality of computer security offense characteristics, as well as to break down various categories of the computer security offense. In an exemplary embodiment, the keywords may be weighted in accordance with a priority set by, for example, a customer. A weighting scheme may be applied to one or more keywords which can affect the selection of an analyst, described in greater detail infra. The weighting scheme may be a numerical value used as a modifier to increase an importance of one or more aspect or characteristic of the computer security offense. For example, a customer may place a higher priority on immediate remediation of offenses relating to a DDoS attack, which means that if a keyword associated with DDoS is detected, then the task assignment application 130 may prioritize a schedule availability of an analyst over the analyst's interests in remediating DDoS attacks, as there may be more than one analyst who has an interest in remediating DDoS attacks. The weighting scheme may be helpful in distinguishing between multiple, ideal candidates to receive a task associated with remediating the offense. In another example, a customer may prefer that only analysts with over 10 years of experience dealing with enterprise management software issues handle offenses pertaining to the customer's enterprise servers. In this example, the task assignment application 130 may prioritize an experience level and a field of expertise of an analyst, as opposed to an analyst that may be immediately available and has an interest in enterprise server maintenance, but only 2 years of experience.

Furthermore, embodiments of the offense module 131 may access or otherwise query an offense database 113, in response to the parsing the computer security offense. Embodiments of the offense database 113 may be one or more databases, storage devices, repositories, and the like, that may store or otherwise contain information and/or data regarding past tasks, issues, offenses, audio recordings and/or text of the audio calls from support/service calls, and the like. The offense database 113 may also be accessed over network 107, and may be affiliated with, managed, and/or controlled by one or more third parties, such as SOCs of a company. The offense module 131 may access the offense database 113 using the keywords to obtain information from other offenses which may be similar, to calculate and/or confirm from previous completed offense an estimated time to completion, a complexity level of the offense, a technical field of the offense, a historical success rate with issues associated with the offense, various tasks that should be generated to remediate the offense, and other computer security offense characteristics.

Accordingly, embodiments of the offense module 131 may analyze the computer security offense to determine one or more characteristics of the computer security offense on a detailed level so that an appropriate analyst may be matched with the offense, using the task assignment application 130.

With continued reference to FIG. 1, embodiments of the computing system 120 may include a calculating module 132. Embodiments of the calculating module 132 may include one or more components of hardware and/or software program code for calculating a match score for a plurality of analyst profiles of an analyst profile system 111. Embodiments of the match score may be a numerical value (e.g. 0-100) that may indicate a strength of a correlation between an analyst profile and the plurality of computer security offense characteristics. For instance, embodiments of the calculating module 132 may access or otherwise utilize the analyst profile system 111 in view of the characteristics of the computer security offense and weighted keywords, to locate an analyst that has a highest match score among a plurality of analysts with the computer security offense characteristics. Embodiments of the calculating module 132 may scan, parse, review, analyze, etc. a plurality of analyst profiles of the analyst profile system 111 to calculate or otherwise determine a match score or relevancy score for each or less then each analyst profile of the analyst profile system 111.

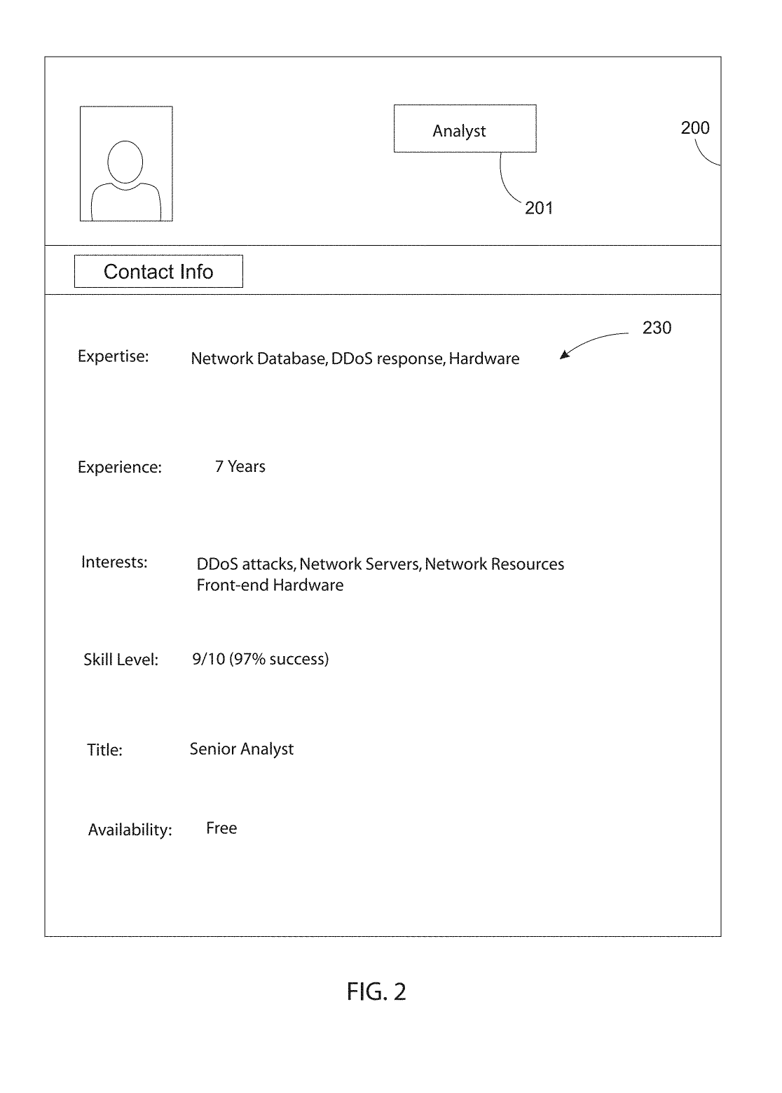

Turning now to FIG. 2, which depicts an analyst profile 200 of the analyst profile system 111, in accordance with embodiments of the present invention. Embodiments of the calculating module 132 may scan, parse, review, analyze, etc., a content 230 of the analyst profile 200, and may first determine whether the content 230 is relevant to the computer security offense characteristics, and then calculate a match score based on a correlation between the offense characteristics and the analyst-specific data. Embodiments of an analyst profile 200 of an analyst 201 may contain content 230 and a name or identity 201 of the analyst and contact information. Here, the content 230 on the analyst profile provide various analyst-specific data, such as expertise, experience, interests, skill level, title, and availability. As an example, if the task assignment application 130 determines that the characteristics of a received offense relate to a DDoS attack, and the customer prioritizes a high skill level/success rate, the selection module 132 may calculate a high match score (e.g. numerical value, 0-100) for the analyst 201. The information/content 230 of the analyst profile 200 indicates that the analyst 201 has a very high skill level which satisfies a priority of the customer, and also indicates that the analyst 201 has expertise in DDoS responses and has an interest in the topic, which means that the analyst-specific data is not only relevant to the offense, but deserving of a high match score (e.g. 92/100). If another analyst profile within the analyst profile system 111 indicates a similar interest but a lower skill level than analyst 201, the calculating module 132 may attribute a lower match score to that analyst. Similarly, if another analyst profile within the analyst profile system 111 indicates a similar skill level but the analyst is not interested in or does not prefer to handle DDoS attacks, then the calculating module 132 may attribute a lower match score to that analyst.

Accordingly, calculating the match score for the analyst profiles, the task assignment application 130 may intelligently distinguish between analysts that may both be competent and capable of handling the task, but effectively selecting the analyst that is more ideal for a particular task, automatically and without manually sorting tasks. Further, the task assignment application 130 enables a workload to be spread across SOCs more evenly to ensure offenses are not all assigned to a single analyst with a heavy workload.

Moreover, as noted above, the analyst-specific data may also include an availability of the analyst in the analyst profile 200. The availability of the analyst may affect the calculation of the match score. For example, embodiments of the offense module 131 may determine how long various offenses/issues take to resolve, using machine learning over time, data from the offense database 113 on previously completed tasks for similar issues, predictive models, and the like. The calculating module 132 may assess a schedule of the analyst either provided in the analyst profile 200 or by interfacing directly with an input device 110 associated with the analyst (e.g. accessing a calendar on the analyst's smart phone), to determine whether the analyst would have time to complete the task. For example, the analyst profile 200 may indicate that the analyst is currently free and available for the next 2 hours, but the calculating module 132 may determine that the task is expected to take 3 hours. In this case, the calculating module 132 may calculate a lower match score for the user because the analyst may be interrupted with other commitments, and adversely affect the analyst's ability to close the task, especially in a high priority/urgent scenario.

Referring back to FIG. 1, embodiments of the computing system 120 may include a selection module 133. Embodiments of the selection module 133 may include one or more components of hardware and/or software program code for selecting an analyst profile with a highest match score of the plurality of analyst profiles. For instance, embodiments of the selection module 133 may evaluate the match scores calculated for the plurality of the analyst profiles of the analyst profile system 111, and select the analyst profile with the highest match score. Moreover, embodiments of the selection module 133 may include one or more components of hardware and/or software program code for verifying that the highest match score exceeds a match score threshold. Embodiments of the match score threshold may be a minimum match score that must be exceeded prior to assigning the task to an analysis. The minimum match score may vary depending on a confidence level required for making a selection based on the analyst-specific data. If the match score threshold is exceeded by the highest match score of the selected analyst profile, then the selection module 133 may complete the selection. If the match score threshold is not met or exceeded, then the selection module 133 may not complete a selection, and may display the computer security offense/task as an open task, available to claim by any analyst that is a part of the SOC.

Furthermore, embodiments of the selection module 133 may assess a condition of the analyst using input device(s) 110, such as one or more sensors, prior to the assigning of the task. Embodiments of the condition of the analyst may include a stress level, a tiredness level of the analyst, a rate of activity of the analyst, a frustration level of the analyst, an alertness level of the analyst, and the like. Embodiments of the one or more sensors used to assess a condition of the user may be positioned within an environment shared by the analyst, worn by the analyst, used by the analyst, or otherwise disposed in a location that can result in obtaining analyst data. Input device 110 may be a sensor, an input device, or any input mechanism. For example, input device 110 may be a biometric sensor, a wearable sensor, an environmental sensor, a camera, a camcorder, a microphone, a peripheral device, a computing device, a mobile computing device, such as a smartphone or tablet, facial recognition sensor, voice capture device, and the like. Embodiments of input devices 110 may also include a heart rate monitor used to track a current or historical average heart rate of the analyst; wireless-enabled wearable technology, such as an activity tracker or smartwatch that tracks a heart rate, an activity level (e.g. number of calories burned, total steps in a day, etc.), a quality of sleep, a diet, a number of calories burned; a robotic therapeutic sensor; a blood pressure monitor; a perspiration sensor; and other wearable sensor hardware. Embodiments of input devices 110 may further include environmental sensors either worn or placed in an analyst environment, such as an office or study, that can measure air quality, temperature, pressure, NO₂ levels, humidity, and the like, which may be helpful in gauging a condition of an analyst.

Further embodiments of input devices 110 may include one or more input devices or input mechanisms, including one or more cameras positioned proximate the analyst or within an environment shared by the analyst. The one or more cameras may capture image data or video data of an analyst, including a posture, facial expressions, perspiration, muscle activity, gestures, etc. Embodiments of the input devices 110 may also include one or more microphones positioned nearby the analyst to collect audio relating to the analyst, a keystroke logger that may measure a rate of typing, and other hardware input devices, such as an audio conversion device, digital camera or camcorder, voice recognition devices, graphics tablet, a webcam, VR equipment, mouse, touchpad, stylus, and the like, which may help gauge a work intensity or work output of an analyst. Further embodiments of sensors 110 may include a mobile computing device, such as a smartphone or tablet device, which may run various applications that contain data about the analyst. For example, an analyst's smartphone may include a sleep tracking application that may send sleep data to the computing system 120, or may send relevant social media information to the computing system 120. The mobile computing device as used as sensor may also utilize the device's camera, microphone, and other embedded sensors to send information to the computing system 120. Moreover, embodiments of input device 110 may encompass other input mechanisms, such as a user computer that may send information to the computing system 120, wherein the analyst computer may be loaded with software programs that are designed to track a productivity or work output level.

Additionally, embodiments of the input devices 110 may be in communication with each other. The input devices 110 may interact with each other for collecting comprehensive, accurate, timely, and organized data, and sending to computing system 120. A first sensor of the one or more sensors may request help from another sensor of the one or more sensors to confirm a condition of the analyst or a data result from the first sensor. For example, a facial recognition sensor may communicatively interact with a perspiration sensor to confirm whether the analyst is indeed sweating, and may additionally communicate with a thermal sensor to determine whether the analyst is possibly sweating based on a temperature of the analyst's environment. The interactive communication between the sensors may modify, update, augment, bolster, confirm, reference, etc. data received and/or collected by the sensor, as well as improve the accuracy and efficiency of the data.

The condition of the analyst may assessed after selection of the analyst, prior to assigning the task to the user as a last step check before proceeding with the automatic assignment of the task, especially when the task is marked with a high severity level or a high priority score. If the analyst's condition is acceptable, for example, not detrimental to performance, then the task may be assigned to the analyst. If the condition of the analyst may result in unacceptable, for example, may act as a detriment to the analyst's performance, the selection module 133 may remove the selected analyst profile, and select the analyst profile with the next highest match score. In further embodiments, the condition data obtained by the input devices 110 may be fed to the analyst profile system 111 so that the task application 130 of computing system 120 may use the condition of the analyst as a factor in calculating the match score.

Referring back to FIG. 1, embodiments of the computing system 120 may also include a task module 134. Embodiments of the task module 134 may include one or more components of hardware and/or software program code for assigning the task associated with the computer security offense to an analyst associated with the selected analyst profile. For instance, embodiments of the task module 134 may automatically assign the task to the analyst associated with the selected analyst profile. Embodiments of the task module 134 may notify the analyst using various electronic communication methods, and may also update a task management software used by the SOC so that all analysts, managers, etc. can view the schedules/tasks.

Various tasks and specific functions of the modules of the computing system 120 may be performed by additional modules, or may be combined into other module(s) to reduce the number of modules. Further, embodiments of the computer or computer system 120 may comprise specialized, non-generic hardware and circuitry (i.e., specialized discrete non-generic analog, digital, and logic-based circuitry) (independently or in combination) particularized for executing only methods of the present invention. The specialized discrete non-generic analog, digital, and logic-based circuitry may include proprietary specially designed components (e.g., a specialized integrated circuit, such as for example an Application Specific Integrated Circuit (ASIC), designed for only implementing methods of the present invention). Moreover, embodiments of the task assignment system 100 offers a method to automatically assign tasks using a cognitive approach to determine ideal matches for completing the task. The task assignment system 100 may be individualized to each analyst/analyst profile, by analyzing the analyst-specific data.

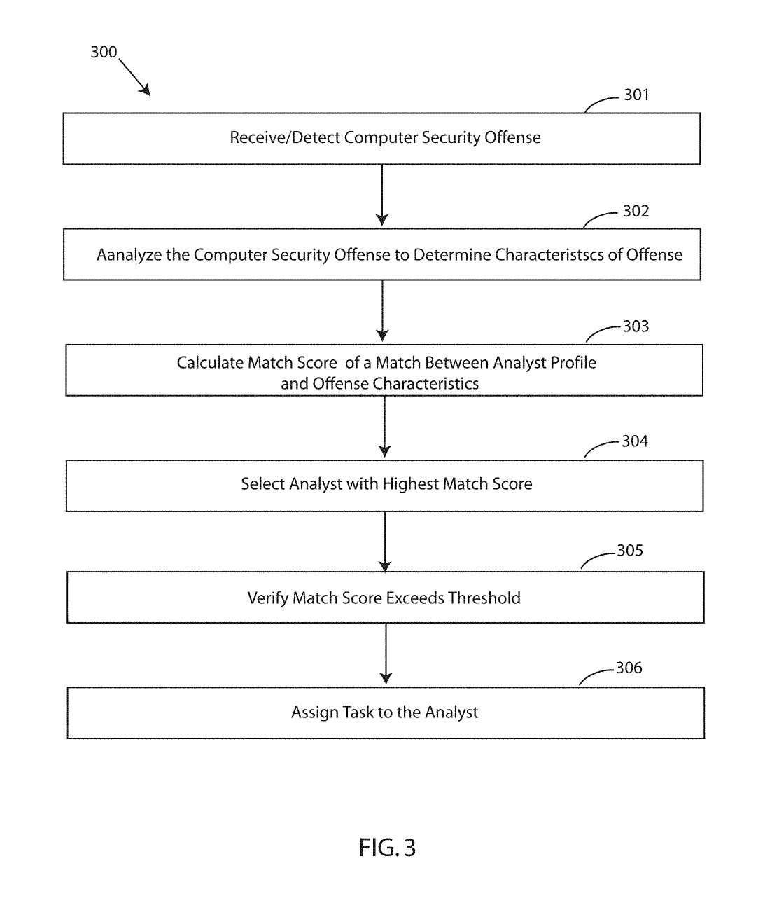

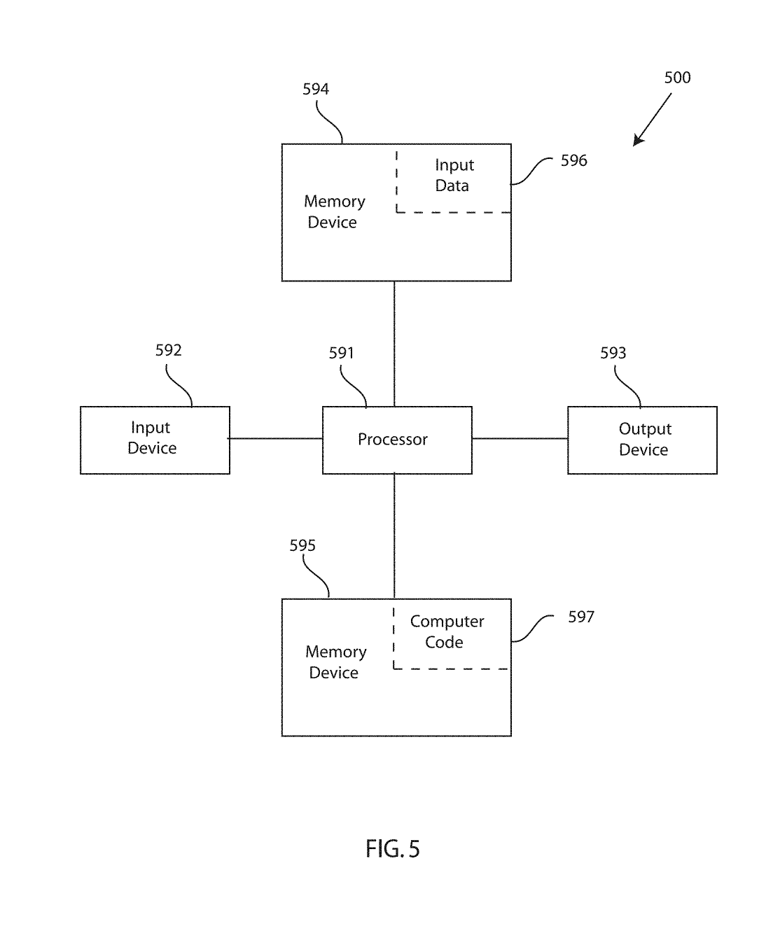

Referring now to FIG. 3, which depicts a flow chart of a method 300 for automatically assigning a task to an analyst of a computer security operation center, in accordance with embodiments of the present invention. One embodiment of a method 300 or algorithm that may be implemented for automatically assigning a task to an analyst of a computer security operation center with the task assignment system 100 described in FIGS. 1-2 using one or more computer systems as defined generically in FIG. 5 below, and more specifically by the specific embodiments of FIG. 1.

Embodiments of the method 300 for automatically assigning a task to an analyst of a computer security operation center, in accordance with embodiments of the present invention, may begin at step 301 wherein a computer security offense is received. Step 302 analyzes the computer security offense to determine characteristics of the offense. Step 303 calculates a match score of a match between the analyst profile and the offense characteristics. Step 304 selects the analyst associated with the analyst profile having the highest match score. Step 305 verifies that the match score of the selected analyst profile exceeds a minimum match score threshold. Step 306 assigns the task to the analyst.

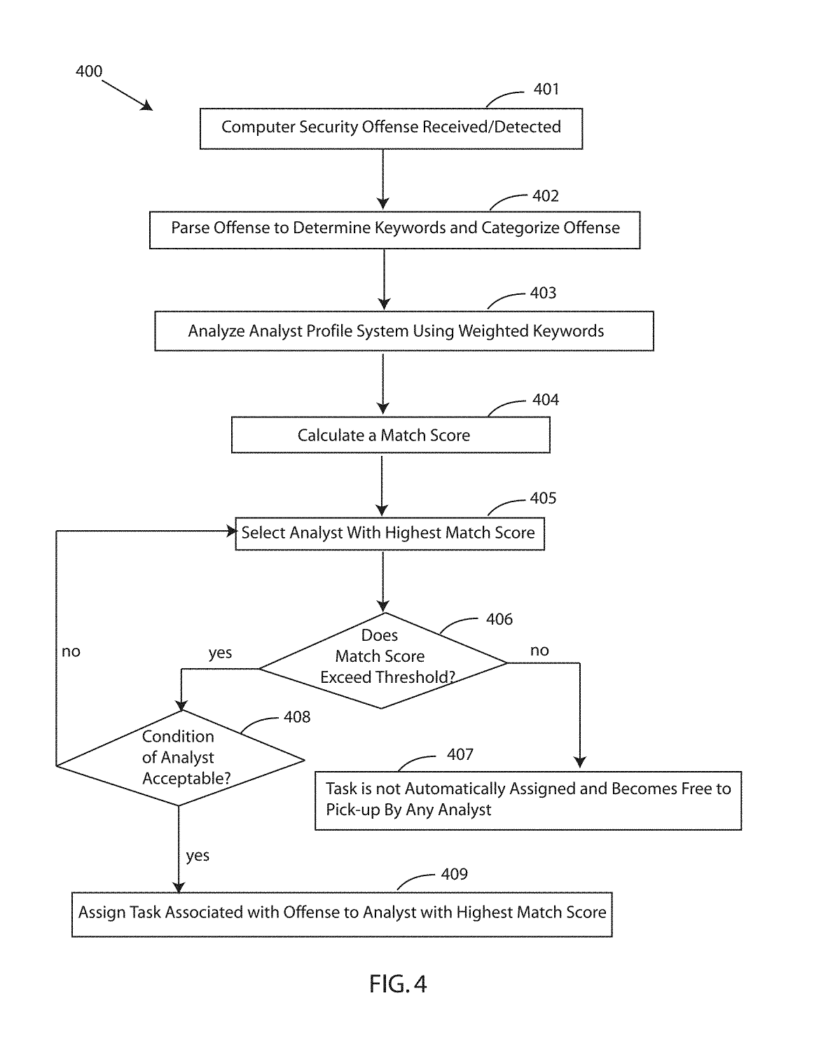

FIG. 4 depicts a detailed flow chart of a method 400 for automatically assigning a task to an analyst of a computer security operation center, in accordance with embodiments of the present invention. Embodiments of the method 400 for automatically assigning a task to an analyst of a computer security operation center may begin at step 401, wherein a computer security is offense is detected/received. Step 402 parses the computer offense to determine keywords and categorize the offense into a plurality of characteristics. Step 403 analyzes the analyst profile system 111 using keywords/weighted keywords. Step 404 calculates a match score. Step 405 selects the analyst profile or analyst with the highest match score. Step 406 determines whether the match score exceeds a minimum match score threshold. If not, then step 407 clears the selection and does not automatically assign the task, such that the task becomes freely available for pick-up by any analyst of the SOC. If yes, then step 408 determines whether a condition of the analyst is acceptable. If no, then step 408 returns to step 405 for selecting a new analyst or new analyst profile having the next highest match score. If yes, then step 409 assigns the task associated with the offense to the analyst with the highest match score and an acceptable condition.

FIG. 5 depicts a block diagram of a computer system for the task assignment system 100 of FIGS. 1-2, capable of implementing methods for automatically assigning a task to an analyst of a computer security operation center of FIGS. 3-4, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer system 500, including executing instructions included in the computer code 597 for the tools and programs capable of implementing a method for automatically assigning a task to an analyst of a computer security operation center in the manner prescribed by the embodiments of FIGS. 3-4 using the task assignment system 100 of FIGS. 1-2, wherein the instructions of the computer code 597 may be executed by processor 591 via memory device 595. The computer code 597 may include software or program instructions that may implement one or more algorithms for implementing the method for automatically assigning a task to an analyst of a computer security operation center, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 5.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a computing device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to task assignment systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer system 500) including one or more processor(s) 591, wherein the processor(s) carry out instructions contained in the computer code 597 causing the computer system to automatically assign a task to an analyst of a computer security operation center. Another embodiment discloses a process for supporting computer infrastructure, where the process includes integrating computer-readable program code into a computer system 500 including a processor.

The step of integrating includes storing the program code in a computer-readable storage device of the computer system 500 through use of the processor. The program code, upon being executed by the processor, implements a method for automatically assigning a task to an analyst of a computer security operation center. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for automatically assigning a task to an analyst of a computer security operation center.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

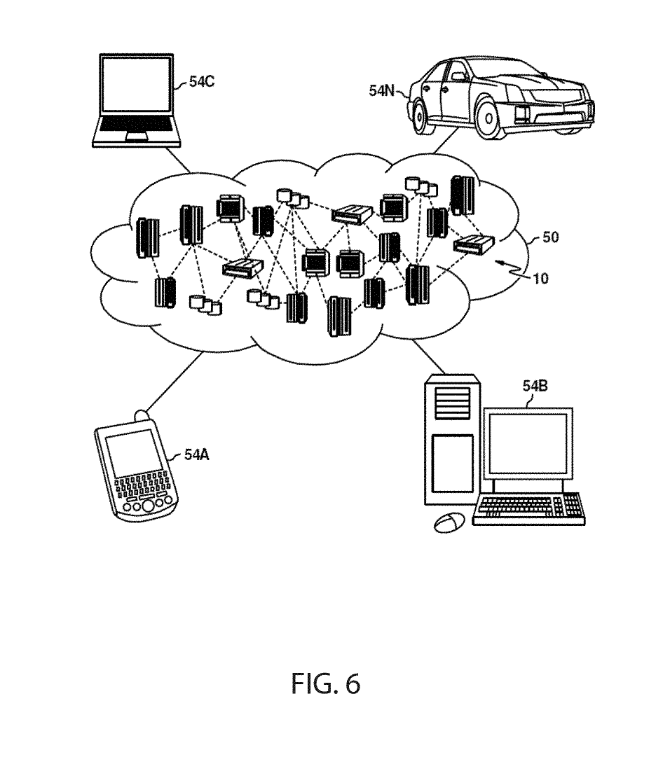

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 10 are intended to be illustrative only and that computing nodes 10 and cloud computing environment 50 can communicate with any type of computerized device over any type of network and/or network addressable connection (e.g., using a web browser).

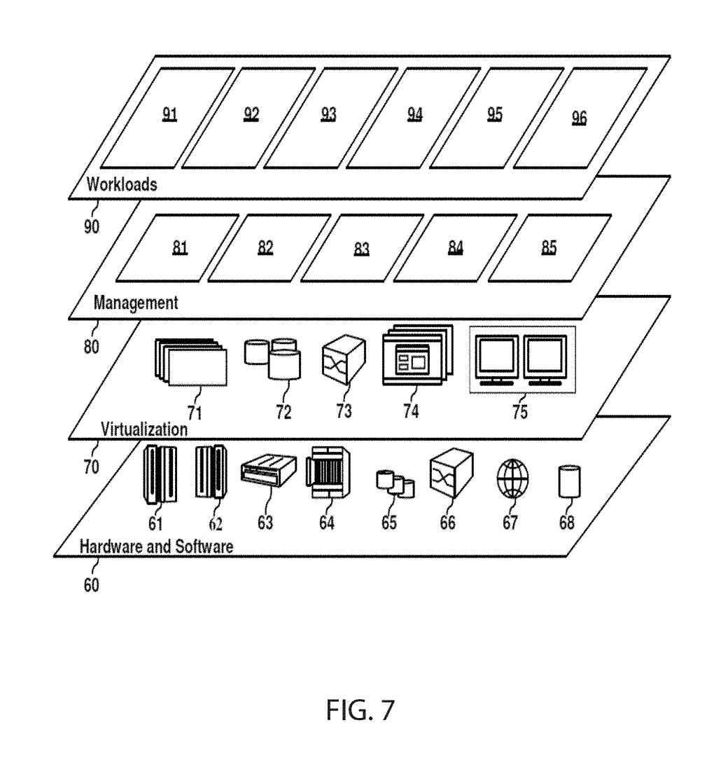

Referring now to FIG. 7, a set of functional abstraction layers provided by cloud computing environment 50 (see FIG. 6) are shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and task assignment 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for automatically assigning a task to an analyst of a computer security operation center, the method comprising:
receiving, by a processor of a computing system, a computer security offense;
analyzing, by the processor, the computer security offense to determine a plurality of computer security offense characteristics;
calculating, by the processor, a match score for a plurality of analyst profiles of an analyst profile system, the match score indicating a strength of correlation between an analyst profile and the plurality of computer security offense characteristics;
selecting, by the processor, an analyst profile with a highest match score of the plurality of analyst profiles;
verifying, by the processor, that the highest match score exceeds a match score threshold; and
assigning, by the processor, the task associated with the computer security offense to an analyst associated with the selected analyst profile.

2. The method of claim 1, wherein the plurality of computer security offense characteristics include an offense type, a complexity of the computer security offense, an estimated time to closing the computer security offense, a technical field of the computer security offense, an urgency of the computer security offense, and a severity level of the computer security offense.

3. The method of claim 1, wherein each analyst profile of the plurality of analyst profiles indicates an expertise of the analyst, a title of the analyst, an experience level of the analyst, an interest of the analyst, an availability of the analyst, a skill level of the analyst, and a success history of the analyst.

4. The method of claim 1, wherein a condition of the analyst is assessed using one or more sensors, prior to the assigning of the task, the condition of the analyst including a stress level, a tiredness level of the analyst, a rate of activity of the analyst, a frustration level of the analyst, and an alertness level of the analyst.

5. The method of claim 4, wherein, when the condition of the analyst precludes the analyst from receiving the assignment, a new analyst with a next highest match score is selected.

6. The method of claim 1, further comprising continuously updating, by the processor, the analyst profile system based on i) data received from the analyst upon completion of the task, ii) sentiment and personality analysis of content shared by the analyst, and iii) real-time data from one or more sensors associated with the analyst.

7. The method of claim 1, further comprising determining, by the processor, a likelihood that the computer security offense is related to an existing computer security offense, as a function of the selecting.

8. A computer system, comprising:
a processor;
a memory device coupled to the processor; and
a computer readable storage device coupled to the processor, wherein the storage device contains program code executable by the processor via the memory device to implement a method for automatically assigning a task to an analyst of a computer security operation center, the method comprising:
receiving, by a processor of a computing system, a computer security offense;
analyzing, by the processor, the computer security offense to determine a plurality of computer security offense characteristics;
calculating, by the processor, a match score for a plurality of analyst profiles of an analyst profile system, the match score indicating a strength of correlation between an analyst profile and the plurality of computer security offense characteristics;
selecting, by the processor, an analyst profile with a highest match score of the plurality of analyst profiles;
verifying, by the processor, that the highest match score exceeds a match score threshold; and
assigning, by the processor, the task associated with the computer security offense to an analyst associated with the selected analyst profile.

9. The computer system of claim 8, wherein the plurality of computer security offense characteristics include an offense type, a complexity of the computer security offense, an estimated time to closing the computer security offense, a technical field of the computer security offense, an urgency of the computer security offense, and a severity level of the computer security offense.

10. The computer system of claim 8, wherein each analyst profile of the plurality of analyst profiles indicates an expertise of the analyst, a title of the analyst, an experience level of the analyst, an interest of the analyst, an availability of the analyst, a skill level of the analyst, and a success history of the analyst.

11. The computer system of claim 8, wherein a condition of the analyst is assessed using one or more sensors, prior to the assigning of the task, the condition of the analyst including a stress level, a tiredness level of the analyst, a rate of activity of the analyst, a frustration level of the analyst, and an alertness level of the analyst.

12. The computer system of claim 11, wherein, when the condition of the analyst precludes the analyst from receiving the assignment, a new analyst with a next highest match score is selected.

13. The computer system of claim 8, further comprising continuously updating, by the processor, the analyst profile system based on i) data received from the analyst upon completion of the task, ii) sentiment and personality analysis of content shared by the analyst, and iii) real-time data from one or more sensors associated with the analyst.

14. The computer system of claim 8, further comprising determining, by the processor, a likelihood that the computer security offense is related to an existing computer security offense, as a function of the selecting.

15. A computer program product, comprising a computer readable hardware storage device storing a computer readable program code, the computer readable program code comprising an algorithm that when executed by a computer processor of a computing system implements a method for automatically assigning a task to an analyst of a computer security operation center, the method comprising:
receiving, by a processor of a computing system, a computer security offense;
analyzing, by the processor, the computer security offense to determine a plurality of computer security offense characteristics;
calculating, by the processor, a match score for a plurality of analyst profiles of an analyst profile system, the match score indicating a strength of correlation between an analyst profile and the plurality of computer security offense characteristics;
selecting, by the processor, an analyst profile with a highest match score of the plurality of analyst profiles;
verifying, by the processor, that the highest match score exceeds a match score threshold; and
assigning, by the processor, the task associated with the computer security offense to an analyst associated with the selected analyst profile.

16. The method of claim 1, wherein the plurality of computer security offense characteristics include an offense type, a complexity of the computer security offense, an estimated time to closing the computer security offense, a technical field of the computer security offense, an urgency of the computer security offense, and a severity level of the computer security offense.

17. The computer program product of claim 15, wherein each analyst profile of the plurality of analyst profiles indicates an expertise of the analyst, a title of the analyst, an experience level of the analyst, an interest of the analyst, an availability of the analyst, a skill level of the analyst, and a success history of the analyst.

18. The computer program product of claim 15, wherein a condition of the analyst is assessed using one or more sensors, prior to the assigning of the task, the condition of the analyst including a stress level, a tiredness level of the analyst, a rate of activity of the analyst, a frustration level of the analyst, and an alertness level of the analyst.

19. The computer program product of claim 18, wherein, when the condition of the analyst precludes the analyst from receiving the assignment, a new analyst with a next highest match score is selected.

20. The computer program product of claim 15, further comprising continuously updating, by the processor, the analyst profile system based on i) data received from the analyst upon completion of the task, ii) sentiment and personality analysis of content shared by the analyst, and iii) real-time data from one or more sensors associated with the analyst.
